(19) United States
(12) Patent Application Publication
(10) Pub. No.: US 2017/0214116 A1
(43) Pub. Date: Jul. 27, 2017

(54) Satellite Dish Base

(71) Applicant: Alfonso Bustos, Everett, WA (US)

(72) Inventor: Alfonso Bustos, Everett, WA (US)

(21) Appl. No.: 15/004,925

(22) Filed: Jan. 23, 2016

(51) Int. Cl. H01Q 1/12

(52) U.S. Cl. CPC H01Q 1/1242; H01Q 1/1228

(57) ABSTRACT

An enclosed Satellite Dish Mount may comprise a base and a mast capable of receiving a variety of different antenna mounts and satellite dishes. Satellite Dish Mount may be configured to be properly installed and operated in typically challenging areas such as apartments and condominiums, for example.

### FIELD

This disclosure relates generally to a satellite dish mount.

### BACKGROUND

Satellite dishes are a popular means of receiving satellite television services, internet services, or other data transmissions. Many people, for example, apartment or condominium tenants, may face contractual prohibitions or restrictions on satellite dish installation. People may also face environmental challenges such as weather, signal interference, and a lack of proper surfaces or directional access on a building or home. Hindrances such as these, for example, may make it difficult or impossible to mount a satellite dish, which may in turn harm business for service providers and diminish quality of life for occupants.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a Satellite Dish Mount, which may comprise a base capable of receiving various types of masts for supporting antenna mounts or satellite dishes. Satellite Dish Mount may be configured to be properly installed and operated in typically challenging areas such as apartments and condominiums, for example.

Many of the attendant features may be more readily appreciated as they become better understood by reference to the following detailed description considered in connection with the attached drawings.

### BRIEF DESCRIPTION OF THE DRAWINGS

FIG. 1 illustrates a flat mount for Satellite Dish Mount, according to one embodiment.

FIG. 2 illustrates a mast for Satellite Dish Mount, according to one embodiment.

FIG. 3 illustrates a mast for Satellite Dish Mount, according to another embodiment.

FIG. 4 illustrates a Satellite Dish Mount, according to one embodiment.

FIG. 5 illustrates a Satellite Dish Mount, according to one embodiment.

FIG. 6 illustrates a Satellite Dish Mount, according to one embodiment.

FIG. 7 illustrates a Satellite Dish Mount, according to one embodiment.

FIG. 8 illustrates a Satellite Dish Mount, according to one embodiment.

FIG. 9 illustrates a Satellite Dish Mount with supporting rods, according to one embodiment.

FIG. 10 illustrates an assembled Satellite Dish Mount with supporting rods, according to one embodiment.

Like reference numerals are used to designate like parts in the accompanying drawings.

### DETAILED DESCRIPTION

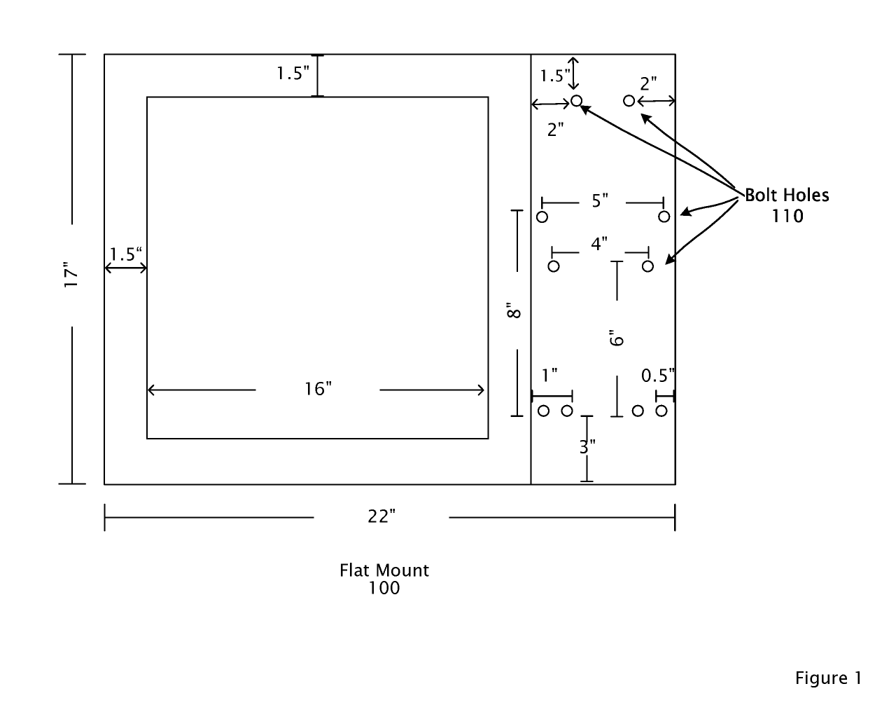

FIG. 1 illustrates Flat Mount 100 for Satellite Dish Mount, according to one embodiment. Flat Mount 100 for Satellite Dish Mount may comprise a base capable of receiving various types of masts suitable for antennae or satellite dishes. Users may also have the option of drilling additional holes to accommodate other models or devices. Satellite Dish Mount may be configured to be properly installed and operated in typically challenging areas such as apartments and condominiums, for example. While this example shows particular dimensions, other embodiments may have different dimensions.

Bolt Holes 110 (four of ten are identified on FIG. 1) may be used to fasten Flat Mount 100 to Mast 200, a wall, a roof, or another surface. Bolt Holes may be, for example, 5/16″ in diameter.

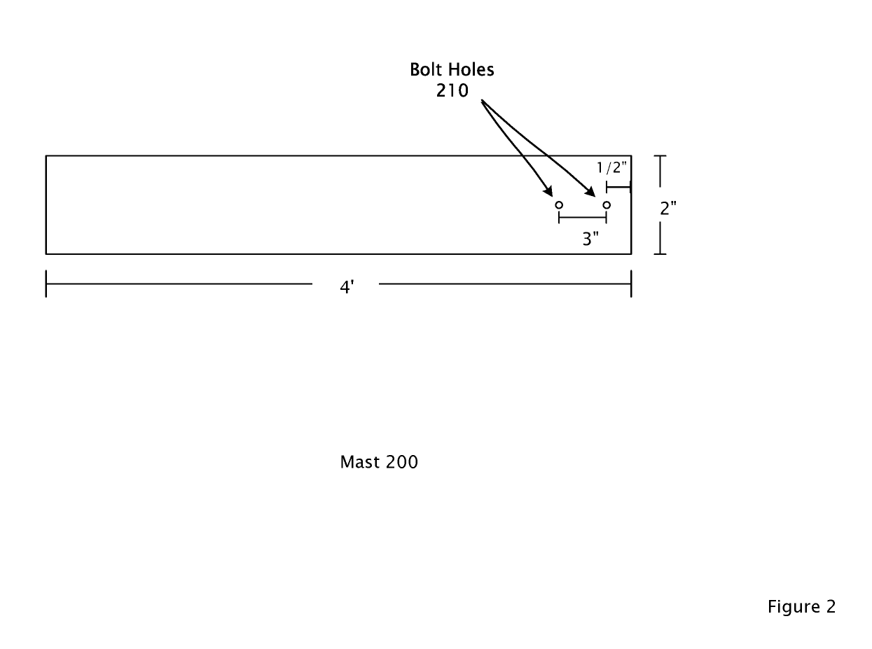

FIG. 2 illustrates Mast 200 for a Satellite Dish Mount, according to one embodiment. Mast 200 may be used to hold a satellite dish a distance off of a floor or ground to allow better positioning. Bolt Holes 210 may be 5/16″ diameter, and may align with Flat Mount 100 or another mount.

While this example shows particular dimensions, other embodiments may have different dimensions.

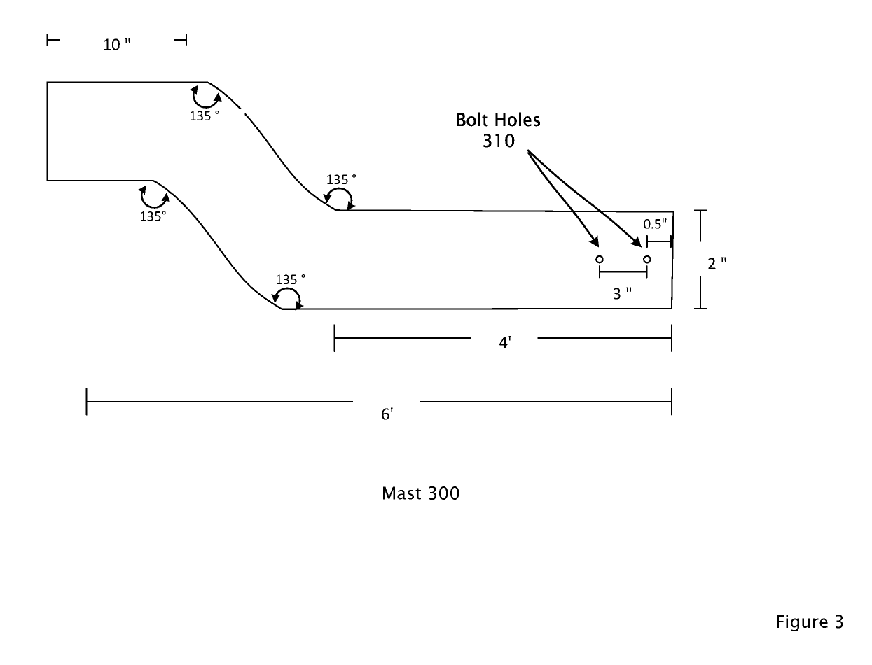

FIG. 3 illustrates Mast 300 for a Satellite Dish Mount, according to another embodiment. Mast 300 may be used to hold a satellite dish a distance off of a floor or ground to allow better positioning. Bolt Holes 310 may be 5/16″ diameter, and may align with Flat Mount 100 or another mount.

While this example shows particular dimensions, other embodiments may have different dimensions.

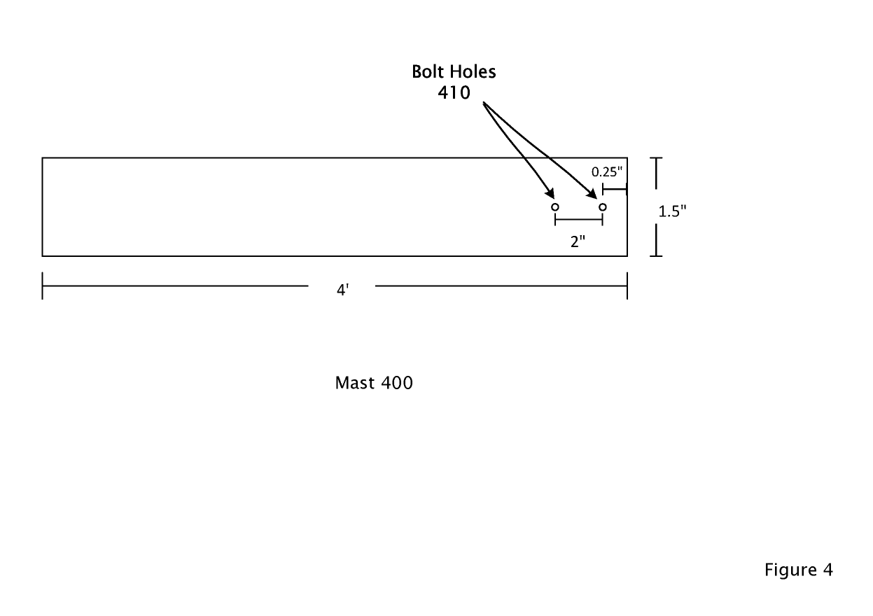

FIG. 4 illustrates Mast 400 for a Satellite Dish Mount, according to another embodiment. Mast 400 may be used to hold a satellite dish a distance off of a floor or ground to allow better positioning. Bolt Holes 410 may be 5/16″ diameter in one embodiment, and may align with Flat Mount 100 or another mount. Mast 400 may be made of various materials, for example plastic, copper, iron, carbon fiber, or fiberglass. Mast 400 may be hollow or solid. One having skill in the art will recognize that various configurations may be appropriate for Mast 400.

While this example shows particular dimensions, other embodiments may have different dimensions.

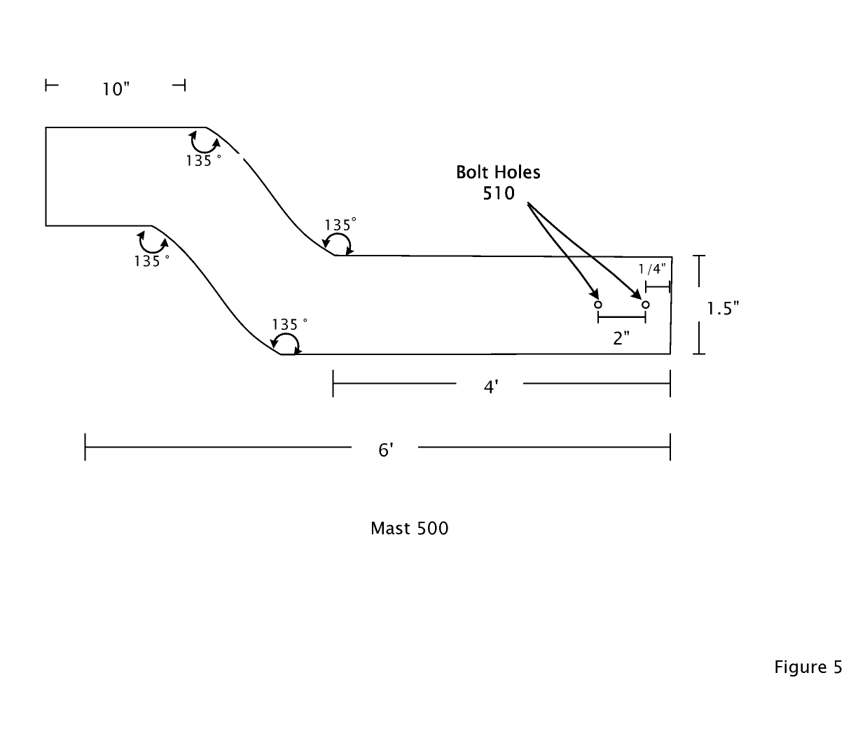

FIG. 5 illustrates Mast 500 for a Satellite Dish Mount, according to another embodiment. Mast 500 may be used to hold a satellite dish a distance off of a floor or ground to allow better positioning. Bolt Holes 510 may be 5/16″ diameter, and may align with Flat Mount 100 or another mount. Mast 400 may be made of various materials, for example plastic, copper, iron, carbon fiber, or fiberglass. Mast 400 may be hollow or solid. One having skill in the art will recognize that various configurations may be appropriate for Mast 400.

While this example shows particular dimensions, other embodiments may have different dimensions.

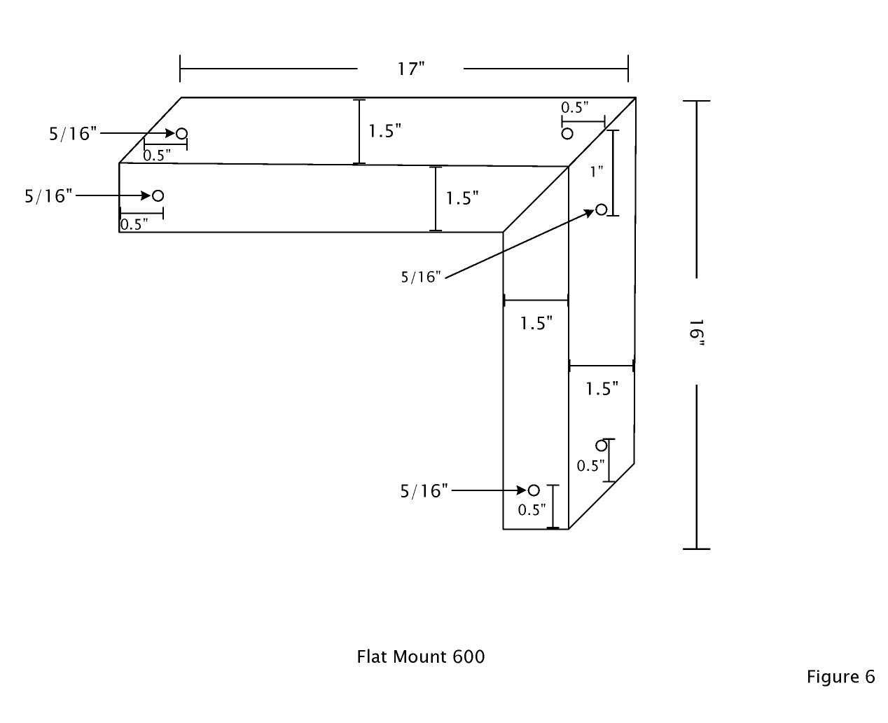

FIG. 6 illustrates a Satellite Dish Mount, according to one embodiment. Flat mount 600 may be coupled to Flat Mount 100 to secure Ballast Weights 910. Flat Mount 600 may, for example, be 1.5″ angle iron. While this example shows particular dimensions, other embodiments may have different dimensions.

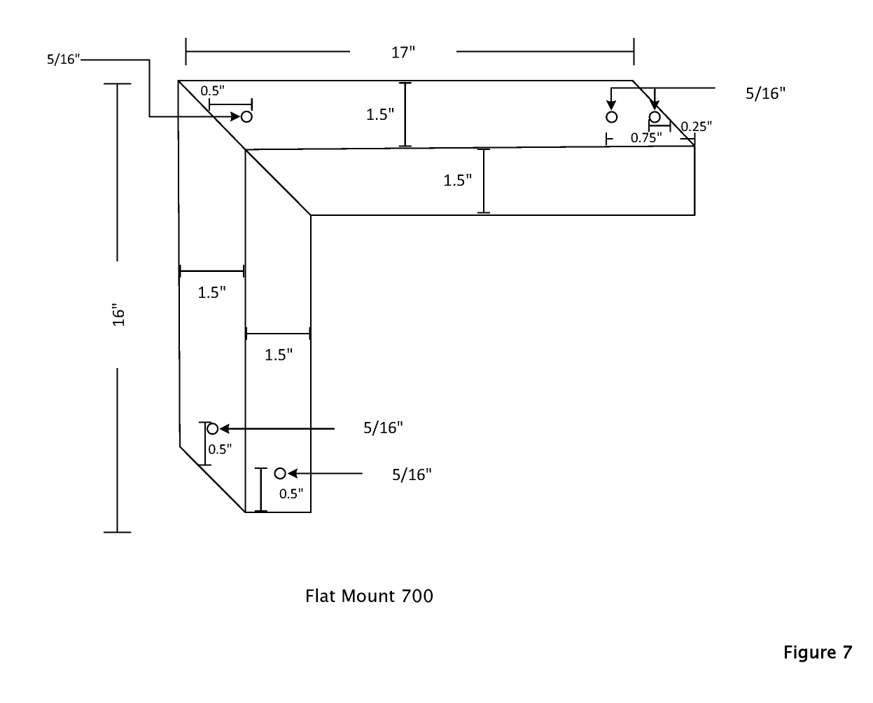

FIG. 7 illustrates a Satellite Dish Mount, according to one embodiment. Flat mount 700 may be coupled to Flat Mount 100 to secure Ballast Weights 910. Flat Mount 600 may, for example, be 1.5″ angle iron. While this example shows particular dimensions, other embodiments may have different dimensions.

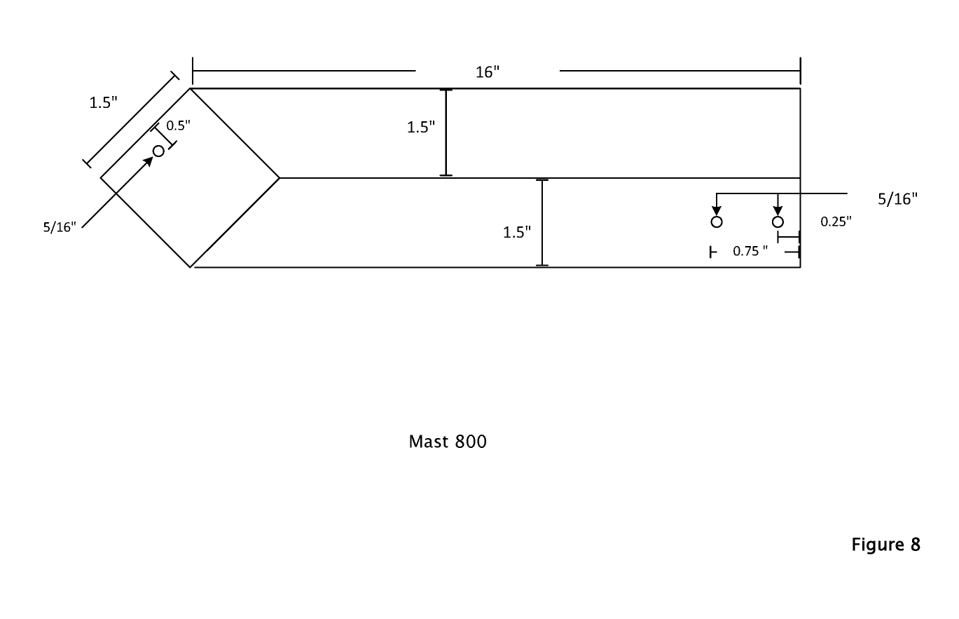

FIG. 8 illustrates a Satellite Dish Mount, according to one embodiment. Mast 800 may be used where a short mast is sufficient to hold a satellite dish at an appropriate height and angle.

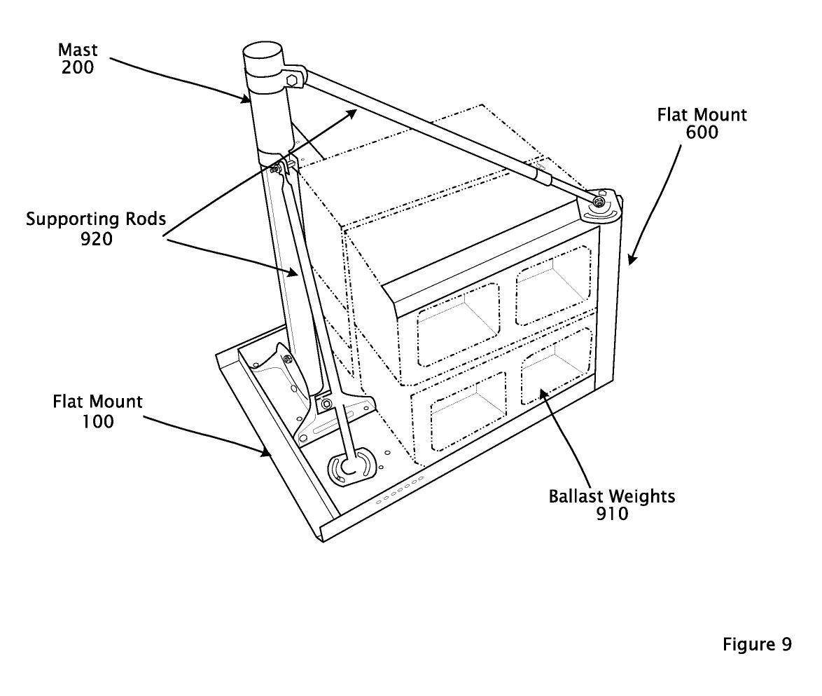

FIG. 9 illustrates a Satellite Dish Mount with supporting rods, according to one embodiment. Mast 200 may be coupled to Flat Mount 100. Supporting Rods 920 may provide support and strength to hold Mast 200 in place. Ballast Weights 910 may be secured using Flat Mount 600 and Flat Mount 700. Ballast weights may be cinder blocks, containers of water, containers of sand, or any other suitably dense material to hold Flat Mount 100 in place.

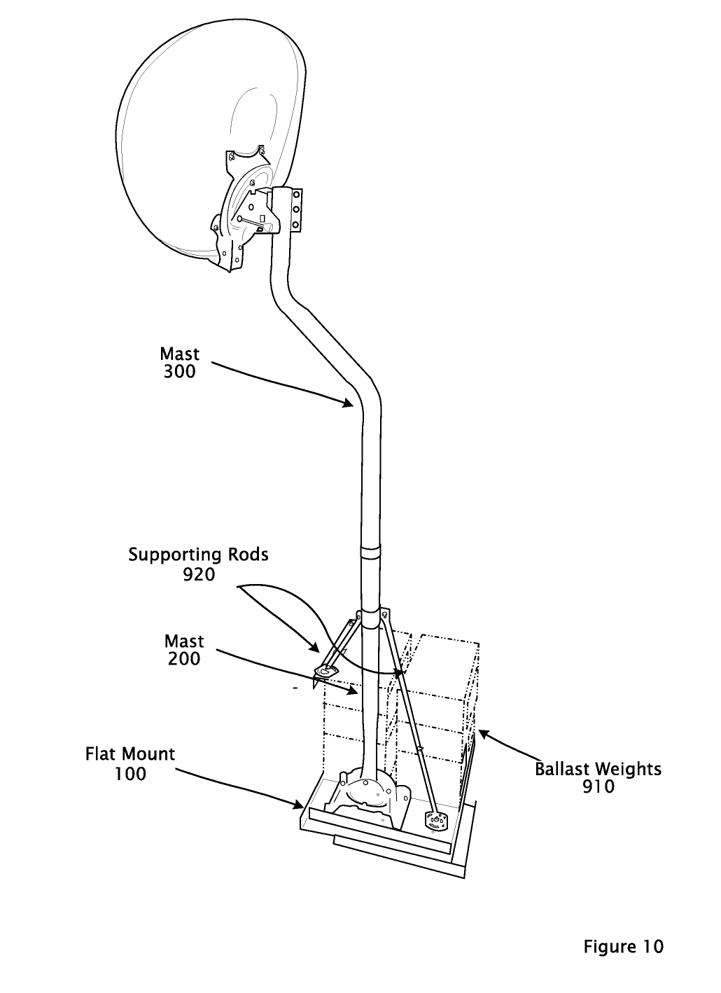

FIG. 10 illustrates an assembled Satellite Dish Mount with supporting rods, according to one embodiment.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A Satellite Dish Mount, comprising:
a base having a plurality of apertures;
an elongated mast, the elongated mast operable to couple at a first end to the base and at a second end to a satellite dish or antenna;
a support rod, the support rod configured to structurally support the elongated mast; and
a flat mount plate, the flat mount plate configured to secure a weight onto the base.

2. The Satellite Dish Mount base cover of claim 1, wherein the base has outer dimensions measuring between 15 inches and 19 inches by between 20 inches and 24 inches.

3. The Satellite Dish Mount apertures of claim 1, wherein the diameter of each aperture is approximately 5/16 inch.

4. The Satellite Dish Mount of claim 1, wherein the apertures are capable of receiving any device from the list containing brackets, braces, hex head bolts, hex nuts, split ring lock washers, flat washers, and self-tapping ground screws.

5. The Satellite Dish Mount of claim 1, wherein the elongated mast is made of a material selected from the list containing plastic, metal, wood, carbon fiber, rubber, and fiberglass.
